(19) United States
(12) Patent Application Publication
(10) Pub. No.: US 2009/0271339 A1
(43) Pub. Date: Oct. 29, 2009

(54) Hierarchical Recognition Through Semantic Embedding

(76) Inventors: Olivier Chapelle, Mountain View, CA (US); Kilian Quirin Weinberger, Mountain View, CA (US)

Correspondence Address: STATTLER - SUH PC, 60 SOUTH MARKET STREET, SUITE 480, SAN JOSE, CA, 95113, US

(21) Appl. No.: 12/111,500

(22) Filed: Apr. 29, 2008

(51) Int. Cl. G06F 15/18

(52) U.S. Cl. 706/12

(57) ABSTRACT

Computer-implemented systems and methods, including servers, perform structure-based recognition processes that include matching and classification. Preprocessing subsystems and sub-methods embed a set of classes on which a loss function is defined into a semantic space and learn an input mapping between an input space and the semantic space. Recognition subsystems and methods accept a test object, representable in the input space, and apply the input mapping to the test object as part of a recognition process.

### BACKGROUND OF THE INVENTION

1. Field of the Invention

The present invention relates to classification and matching with a large number of structured classes.

2. Art Background

The problem of classification with a very large number of structured classes is of increasing interest in Internet business: many systems in search and advertising depend on query, page and ad categorization. For instance, in typical content match schemes both the page and the ads are placed into a hierarchy of topics; the selection of the ads is such that the topic of the page and the ad are similar; in this way, the advertisement appears to be relevant to the content of the page.

Given a set of classes organized in a taxonomy, and a collection of objects potentially classifiable into a class from the set of classes, there are related problems of classifying the objects classification and of matching objects to one anther. One approach is termed “one-vs.-the-rest”, where a classifier is trained for each class. The most-common classification strategy employed is “flat” classification, which ignores the hierarchical relationship between classes. For example, “scuba diving” and “swimming” classes are both similar to each other and very different from an “automobile” class.

### SUMMARY OF THE INVENTION

In the case of a taxonomy of classes, a loss function on a set of classes, or some other structure defining relationships between classes, there exists information about the relationship between different classes. Embodiments consistent with the present invention use this information to embed the different classes into a semantic space, where similar classes are close together, preferably in terms of vector similarity within the semantic space, and different classes are far away. Methods and systems consistent with some embodiments then cast the structured classification problem into a (computationally easier) multidimensional regression problem. These embodiments learn a mapping from an input space to the semantic space. For a test pattern, the predicted class is the one with the smallest distance in that space between the mapped test point and the class representatives. In case of matching, the distance between two entities reflect their semantic dissimilarity and the class information is not needed.

In one aspect, embodiments of the present invention relate to computer-implemented system for structure-based recognition. For example, one system comprising a preprocessing subsystem for embedding a set of classes on which a loss function is defined into a semantic space and for learning an input mapping between an input space and the semantic space, and a recognition subsystem for accepting a test object that is representable in the input space and applying the input mapping to the test object as part of a recognition process. In this aspect preferred recognition processes include matching and classification.

In another aspect, embodiments relate to computer-implemented methods of structure-based recognition. For example, a method comprising an embedding step, a learning step, and applying step. The embedding step comprises a set of classes on which a loss function is defined into a semantic space. The learning step comprises learning an input mapping between an input space and the semantic space. The applying step comprises applying the input mapping to a test object that is representable in the input space as part of a recognition process. In this aspect preferred recognition processes include matching and classification.

In still another aspect, embodiments relate to recognition servers. For example a recognition server that operates on a collection of objects, wherein each object belongs to an input space, and on a hierarchy of classes. For example, such a server includes a preprocessing module and a recognition module. The preprocessing module is for embedding the classes from the hierarchy of classes into a semantic space and for learning an input mapping between an input space and the semantic space. The input mapping is based on a training set of objects from the input space associated with classes in the hierarchy of classes. The recognition module is for applying the input mapping to the collection of objects as part of a recognition process. In this aspect preferred recognition processes include matching and classification.

### BRIEF DESCRIPTION OF THE DRAWINGS

FIG. 1a is an exemplary search results page of a commercial search engine, which comprises algorithmic search results and advertisements in various locations of the page.

FIG. 1b is an exemplary web page running content matched advertisements; the page comprises content and advertisements in various locations of the page.

FIG. 2 is a diagram outlining backend processing steps required to produce a search results page and a content-matched advertising page.

FIG. 3a is a conceptual depiction of a set of classes arranged in a hierarchy consistent with some embodiments of the present invention.

FIG. 3b is a conceptual depiction of a semantic space, an input space, and a set of classes consistent with some embodiments of the present invention.

FIG. 4 is a flowchart illustrating a hierarchical recognition system consistent with some embodiments of the present invention.

FIG. 5a is a flowchart illustrating an embedding step of a preprocessing portion of a hierarchical recognition system consistent with some embodiments of the present invention.

FIG. 5b is a flowchart illustrating a regression step of a preprocessing portion of a hierarchical recognition system consistent with some embodiments of the present invention.

FIG. 5c is a flowchart illustrating a matching application of a hierarchical recognition system consistent with some embodiments of the present invention.

FIG. 5d is a flowchart illustrating a classification application of a hierarchical recognition system consistent with some embodiments of the present invention.

### DETAILED DESCRIPTION

### Advertising

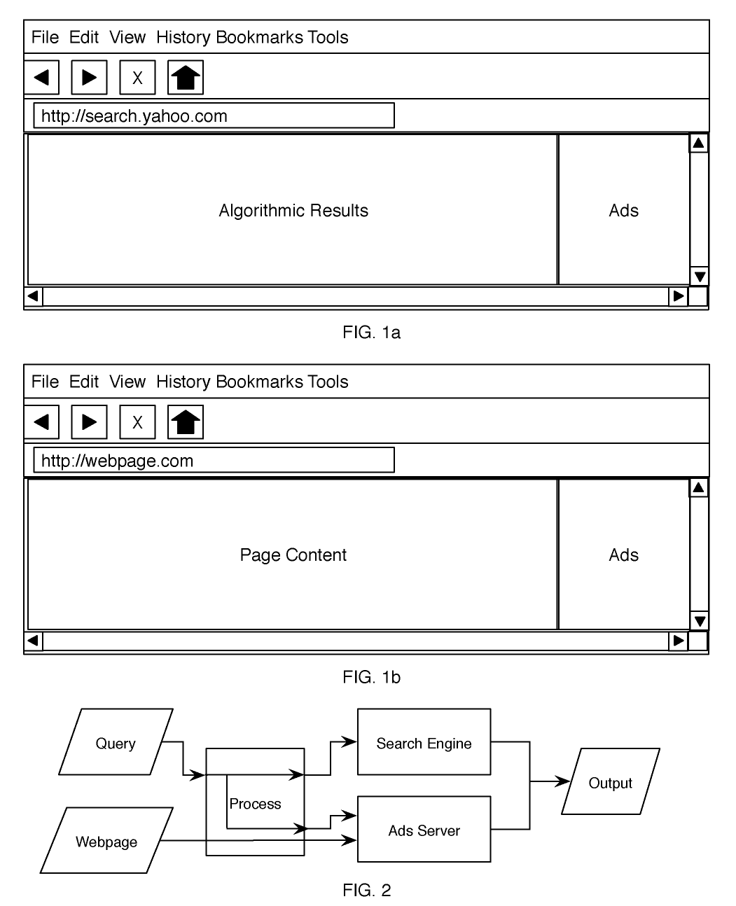

Users of the Internet are familiar with typical commercial search engines. FIG. 1a illustrates an exemplary search results page (SRP) returned by a commercial search engine in response to a query. The right column of the page comprises advertisements. The left column of the page comprises algorithmic search results.

Internets users also recognize typical advertisement serving schemes. FIG. 1b illustrates an exemplary web page with advertisements served based on web page content. The right column of the page comprises advertisements. The left column of the page comprises content.

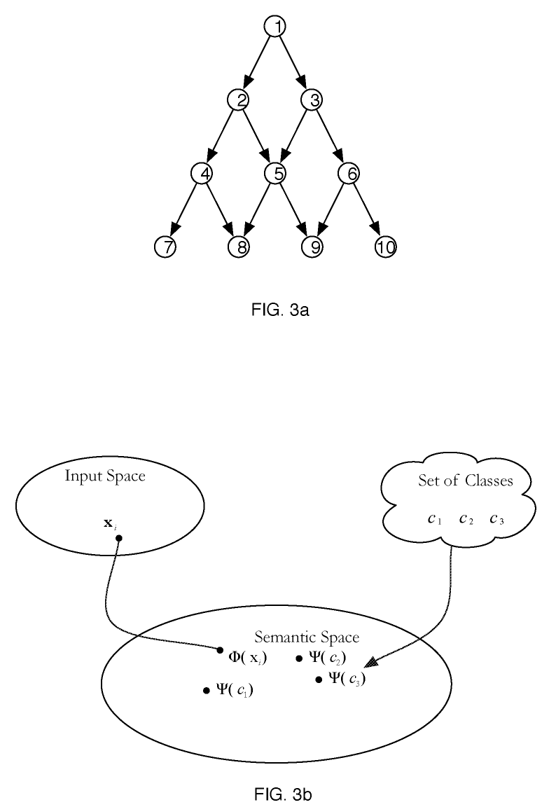

FIG. 2 shows a typical workflow by which an SRP or set of content-matched ads is generated in response to a search query or web page content. In the case of a query, the query is first processed. Typical processing operations include filtering, sanitization, stemming, stop-word removal, and canonical format conversion. The processed query is provided to two separate sub-process pipelines. The first pipeline ranks all web content, which is usually referenced by a URL or URI on the World-Wide-Web, in order of relevance to the pre-processed query. This ranking forms the algorithmic search results set for query. The second pipeline ranks all available ads, either text-based or graphical, also in order of relevance to the pre-processed query. The SRP delivered in response to the query draws on both rankings: of ads and of algorithmic results. Typically, SRP construction involves both rankings and includes a default sub-process to determine the layout of the ads on the page. Typically the rankings determine placement of ads within the layout. Though such advertising layout algorithms may formulate advertisement placement in different ways, they use query and individual ad-level features to determine placement.

In the case of web page content, the content is also processed first. Again, typical processing operations include filtering, sanitization, stemming, stop-word removal, and canonical format conversion. The processed content is provided to an ad-ranking pipeline that ranks all available ads, either text-based or graphical, also in order of relevance to the pre-processed query. Ad serving typically involves determining the layout of the ads on the page. Typically the rankings determine placement of ads within the layout. Though such advertising layout algorithms may formulate advertisement placement in different ways, they use page content and individual ad-level features to determine placement.

In either the search or web page contexts, the ordering of advertisements often relies on a matching process. In the search context, advertisements are matched to the query. In the web page context, ads are matched to page content.

### Classification and Taxonomies

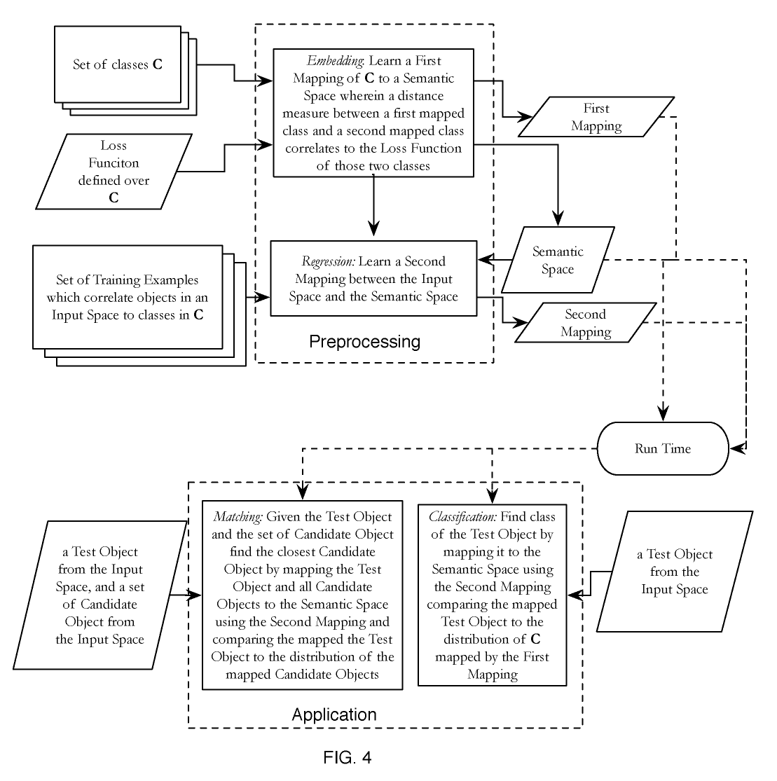

In the abstract, embodiments of the present invention are concerned with classes. For example, in some cases there are 10 classes. Preferably the classes are organized in a taxonomy, such as shown in FIG. 3a where class 1 is the root class and classes 7, 8, 9, and 10 are leaves. More generally, we only need to know a loss (or equivalent similarity) function L defined between two classes. From a taxonomy, there are several ways of defining this loss function. For example, the path length between classes defines one type of loss function, e.g. L(7,8) is less than L(7,10).

As another example, in a case where there are k classes c₁, . . . cₖ it's possible to define a loss function based on class probabilities:

L(c₁, c₂)=2 log(p(Anc(c₁, c₂)))−log(p(c₁))−log(p(c₂)).

Here Anc(c₁, c₂) is the common ancestor of c₁ and c₂ and p(c) is the fraction of training samples, from a set of training samples, whose class is in the sub tree rooted at c. Connecting this example back to the previous case, perhaps the training samples are in classes 2, 7, 8, and 10, and we wish to compare L(7,10) to L(7,8). Here Anc(7,10) is class 1 and Anc(7,8) is class 4. Meanwhile p(1)=1, p(7)=0.25, p(8)=0.25, p(4)=0.5 and p(10)=0.25. Thus, L(7,10)=2*log(1)−2*log(0.25) and L(7,8)=2*log(0.5)−2*log(0.25). Here it is clear that L(7,8) is less than L(7, 10) as log(1) evaluates to zero.

It is important to note that some embodiments of the present invention need only a defined loss function and not a taxonomy; in other words, the function L might have been constructed without a taxonomy.

FIG. 3b illustrates the general approach of some embodiments. Given an Input Space and k classes c₁, . . . , cₖ, a Semantic Space, preferably of lower dimensionality than the input space, is constructed and each class cₚ is mapped to a class “representative” Ψ(cₚ). The mapping Ψ is constructed such that the distance between two representatives is related to the similarity between the classes. In the example of this figure, the class c₂ is similar to c₃ but very different from c₁. Then a linear mapping Φ is learned from the Input Space to the Semantic Space.

Methods consistent with some embodiments are powerful classification algorithms. However, they also excel at the following matching problem: given an instance, find another similar instance (with respect to the given taxonomy). The so-called content match problem described above—for a given page find a semantically related ad—is an instance of the matching problem. As mentioned earlier, many current systems work by classifying the instances into a taxonomy. Note that in this case, classification is a means not an end. Methods consistent with some embodiments of the present invention are able to shortcut the classification problem and solving the matching problem directly.

Implementations

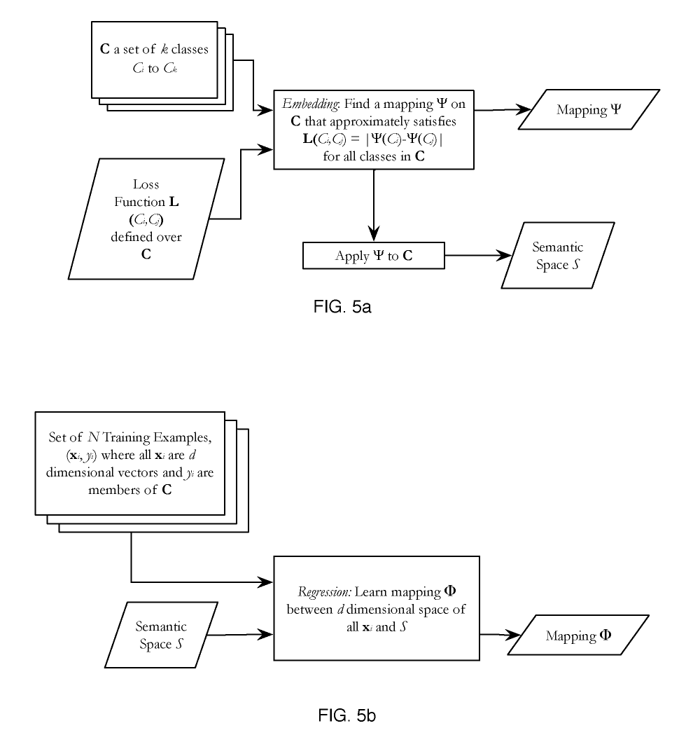

FIG. 4 illustrates a hierarchical recognition system consistent with some embodiments of the present invention. The system of FIG. 4 supports multiple recognition processes, including Classification and Matching. In FIG. 4, the system includes preprocessing and application subsystems.

The preprocessing subsystem performs Embedding and Regression processes. The Embedding process takes a set of classes C and a Loss Function defined over C as inputs. During the Embedding process the preprocessing subsystem learns a first mapping of C to a Semantic Space wherein a distance measure between a first mapped class and a second mapped class correlates to the Loss Function on those two classes. The First Mapping learned during this process relates classes to the Semantic Space.

The Regression process takes the First Mapping as an input. In some embodiments the Regression process takes the Semantic Space as an input, though preferably the Semantic Space is an implicit input given the classes and the First Mapping. Another input to the Regression process is a set of training examples, which correlate objects in an Input Space to classes in C. The Second Mapping learned during this process relates the Input Space to the Semantic Space.

At run time, the Second Mapping, or the Second and the First Mappings, are used in recognition processes by an application subsystem. In some embodiments, a classification process is performed at run time on a Test Object from the Input Space. In this process, the application subsystem finds a class of the Test Object by mapping it to the Semantic Space using the Second Mapping comparing the mapped Test Object to the distribution of C mapped by the First Mapping.

In some embodiments a matching process is performed at run time on a Test object from the Input Space and a set of Candidate Object from the Input Space. The matching process, given the Test Object and the set of Candidate Object, finds the closest Candidate Object by mapping the Test Object and all Candidate Objects to the Semantic Space using the Second Mapping and comparing the mapped the Test Object to the distribution of the mapped Candidate Objects.

Further Details

To simplify notation, the description below refers to a set of k classes c₁, . . . , cₖ, termed C and a set of N training examples, (xᵢ, yᵢ), 1≦i≦n, where xᵢεER^{d} and yᵢε{c₁, . . . , cₖ}.

The classes are preferably organized in a taxonomy, but more generally, we only need to know a loss (or equivalent similarity) function L defined between two classes.

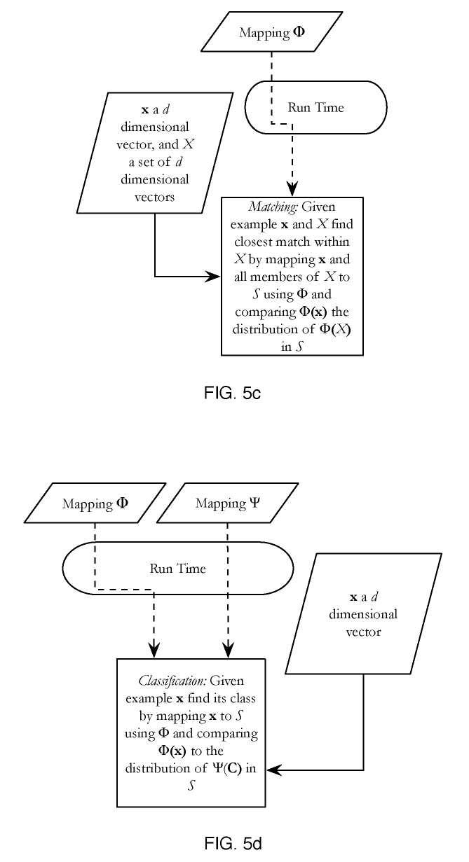

FIGS. 5a and 5b illustrate a preprocessing portion of some embodiments of the invention in more detail. FIG. 5a illustrates an embedding step. Embedding comprises finding a mapping Ψ on C that approximately satisfies ∥Ψ(cₚ)−Ψ(c_{q})∥=L(cₚ, c_{q}), ∀1≧p, q≧k. Application of the mapping Ψ to C produces a semantic space S. Each class cₚ is represented in that space by a vector Ψ(cₚ)εS. The distances in that space are supposed to reflect semantic dissimilarity, where the dissimilarity is quantified through the loss function L.

In embodiments of the invention embedding is achieved through various techniques such as Multidimensional Scaling (MDS). MDS finds the Ψ(cₚ) such that the above equalities are approximately satisfied in the mean squared sense. The dimensionality of S is automatically found by MDS algorithms. However, in some embodiments during this embedding phase components with small variance are eliminated to further reduce the dimensionality of S.

FIG. 5b illustrates a regression step. In some embodiments regression involves learning a mapping Φ: R^{d}→S from the d dimensional Input Space to the Semantic Space. Preferably this is achieved by a standard regression algorithm. For example, some embodiments use regularized linear regression, Φ(x)=W x, where the m×d matrix W is found as the minimizer of the following objective function:

$$W = \text{arg} {min}_{W} \frac{1}{2} {\sum }_{j , k} {W}_{j , k}^{2} + {\sum }_{i} {( {Wx}_{i} - Φ ( {u}_{i} ) )}^{2}$$

FIGS. 5c and 5d illustrate application steps completed at run time in some embodiments consistent with the invention. In both FIGS. a pattern is mapped into the semantic space. FIG. 5c illustrates a matching process. Consistent with some embodiments the matching process operates on a test object from the input space and a collection of candidate objects from the input space. In the case of a d dimensional input space, for example x, a d dimensional vector, is a test object and X a set of d dimensional vectors is the collection of candidate objects. Also consistent with some embodiments a matching process takes a mapping from the input space to the semantic space, e.g. Φ, as an input. Proceeding with this notation, a matching process operating on x and X finds a closest match within X by mapping x and members of X to S using Φ and comparing Φ (x) the distribution of Φ (X) in S.

Preferably in the case of matching, the Euclidian distance of the mapped points reflects their dissimilarity. In some embodiments, given the test point x and X a set of points we would like to match x against, the match is given by:

$$match ( x ) = \text{arg} {min}_{{x}^{′} ∈ X} ‖ φ ( x ) - Φ ( {x}^{′} ) ‖$$

FIG. 5d illustrates a classification process. Consistent with some embodiments the classification process operates on a test object from the input space. In the case of a d dimensional input space, for example x, a d dimensional vector, is a test object. Also consistent with some embodiments a classification process takes a mapping from the input space to the semantic space, e.g. Φ, and a mapping from the classes to the semantic space, e.g. Ψ, and a set of classes C as inputs. Proceeding with this notation, a classification process operating on x and C finds the class of x by mapping x to S using Φ and comparing Φ(x) the distribution of Ψ(C) in S.

Preferably in the case of classification, the class membership can be inferred from the distances to the class representatives in the semantic space. In various embodiments this inference proceeds either probabilistically or by looking at the minimum distance. For example, in some embodiments the predicted class of a test example x is given by the following:

$$c = \text{arg} {min}_{x ∈ ( {c}_{i} , … , {c}_{j} )} ‖ Φ ( x ) - Φ ( c ) ‖$$

Advantages

Embodiments of the invention account for class hierarchy in ways that result in greater matching and classification accuracy. In many embodiments training and test times are shorter than prior methods because the dimensionality of the semantic space is lower than the number of classes.

In matching problems such as encountered in sponsored search and content match, both ads and pages can be mapped to a semantic space, providing a measure of semantic similarity. Thus for matching, embodiments of the present invention need not even infer class membership.

In the case of content match, embedding of page and ad features into a semantic space provides a measure of dissimilarity as well as similarity. This can be useful in scenarios when the compatibility of ads and web pages needs to be established.

Methods and systems consistent with the present invention incorporate relationships among classes. Such methods can scale up to very large taxonomies and can handle cases where there are more classes than training examples; in such cases a flat classification algorithm is bound to fail.

Although the present invention has been described in terms of specific exemplary embodiments, it will be appreciated that various modifications and alterations might be made by those skilled in the art without departing from the spirit and scope of the invention. The scope of the invention is not limited to the exemplary embodiments described and should be ascertained by inspecting the appended claims.

What is claimed is:

1. A computer-implemented system for structure-based recognition, comprising:
a. a preprocessing subsystem for embedding a set of classes on which a loss function is defined into a semantic space and for learning an input mapping between an input space and the semantic space; and
b. a recognition subsystem for accepting a test object that is representable in the input space and applying the input mapping to the test object as part of a recognition process.

2. The computer-implemented system of claim 1, wherein the preprocessing subsystem embeds the set of classes into the semantic space by finding a mapping from a class space in which the classes are represented to a space in which the vector similarity of two given classes is related to the loss function of those two given classes.

3. The computer-implemented system of claim 2, wherein the set of classes are from a taxonomy and the loss function is defined based on the taxonomy.

4. The computer-implemented system of claim 2, wherein the preprocessing subsystem uses multi-dimensional scaling to embed the set of classes into the semantic space.

5. The computer-implemented system of claim 1, wherein the recognition process comprises matching an object from a collection of candidate objects to the test object.

6. The computer-implemented system of claim 5, wherein the recognition process comprises applying the input mapping to the collection of candidate objects.

7. The computer-implemented system of claim 1, wherein the recognition process comprises classifying the test object.

8. The computer-implemented system of claim 7, wherein classifying the object comprises comparing the location of the input mapped test object in the semantic space to the distribution of the set of classes in the semantic space.

9. The computer-implemented system of claim 8, wherein the object is classified based on the class closest to the mapped test object in the semantic space.

10. The computer-implemented system of claim 1, wherein learning an input mapping comprises using linear regression on the input space and semantic space.

11. A computer-implemented method of structure-based recognition, comprising:
a. embedding a set of classes on which a loss function is defined into a semantic space;
b. learning an input mapping between an input space and the semantic space; and
c. applying the input mapping to a test object that is representable in the input space as part of a recognition process.

12. The computer-implemented method of claim 10, wherein learning an input mapping comprises using linear regression on the input space and semantic space.

13. The computer-implemented method of claim 10, wherein embedding the set of classes into the semantic space comprises finding a mapping from a class space in which the classes are represented to a space in which the vector similarity of two given classes is equivalent to the loss function of those two given classes.

14. The computer-implemented method of claim 10, wherein the recognition process comprises matching an object from a collection of candidate objects to the test object.

15. The computer-implemented method of claim 14, wherein the recognition process comprises applying the input mapping to the collection of candidate objects.

16. The computer-implemented method of claim 10, wherein the recognition process comprises classifying the test object.

17. The computer-implemented method of claim 16, wherein classifying the object comprises comparing the location of the input mapped test object in the semantic space to the distribution of the set of classes in the semantic space.

18. The computer-implemented method of claim 10, wherein the set of classes are from a taxonomy and the loss function is defined based on the taxonomy.

19. A recognition server operating on a collection of objects, wherein each object belongs to an input space, and a hierarchy of classes, comprising:
a. a preprocessing module for embedding the classes from the hierarchy of classes into a semantic space and for learning an input mapping between an input space and the semantic space based on a training set of objects from the input space associated with classes in the hierarchy of classes; and
b. a recognition module for applying the input mapping to the collection of objects as part of a recognition process.

20. The recognition server of claim 19, wherein a loss function is defined over the hierarchy and embedding the set of classes into the semantic space comprises finding a mapping from a class space in which the classes are represented to a space in which the vector similarity of two given classes is equivalent to the loss function of those two given classes.

21. The recognition server of claim 19, wherein the recognition process comprises matching an object from a collection of candidate objects to the test object.

22. The recognition server of claim 21, wherein the recognition process comprises applying the input mapping to the collection of candidate objects.

23. The recognition server of claim 19, wherein the recognition process comprises classifying the test object.

24. The recognition server of claim 23, wherein classifying the object comprises comparing the location of the input mapped test object in the semantic space to the distribution of the set of classes in the semantic space.
